(19) United States
(12) Patent Application Publication
(10) Pub. No.: US 2009/0056575 A1
(43) Pub. Date: Mar. 5, 2009

(54) Pattern transfer apparatus

(76) Inventors: Jon A. Bartman, Corvallis, OR (US); William M. Tong, San Francisco, CA (US); Wei Wu, Mountain View, CA (US); YuFong Chen, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/897,776

(22) Filed: Aug. 31, 2007

(51) Int. Cl. B41F 1/16

(52) U.S. Cl. 101/382.1; 101/492

(57) ABSTRACT

A pattern transfer apparatus including an inflatable membrane is described.

### BACKGROUND

Pattern transfer devices may be used to transfer a nano imprinted pattern from a patterned platen to a substrate. Due to the small size of components of the nano imprinted pattern being transferred, precise control of the transfer process may allow improved quality of the transferred pattern.

### BRIEF DESCRIPTION OF THE DRAWINGS

FIGS. 1 and 2 are schematic views of one example embodiment of a pattern transfer apparatus during a transfer method.

FIG. 3 is a detailed cross sectional side view showing a portion of a pattern and a corresponding portion of substrate that has been patterned.

### DETAILED DESCRIPTION OF THE DRAWINGS

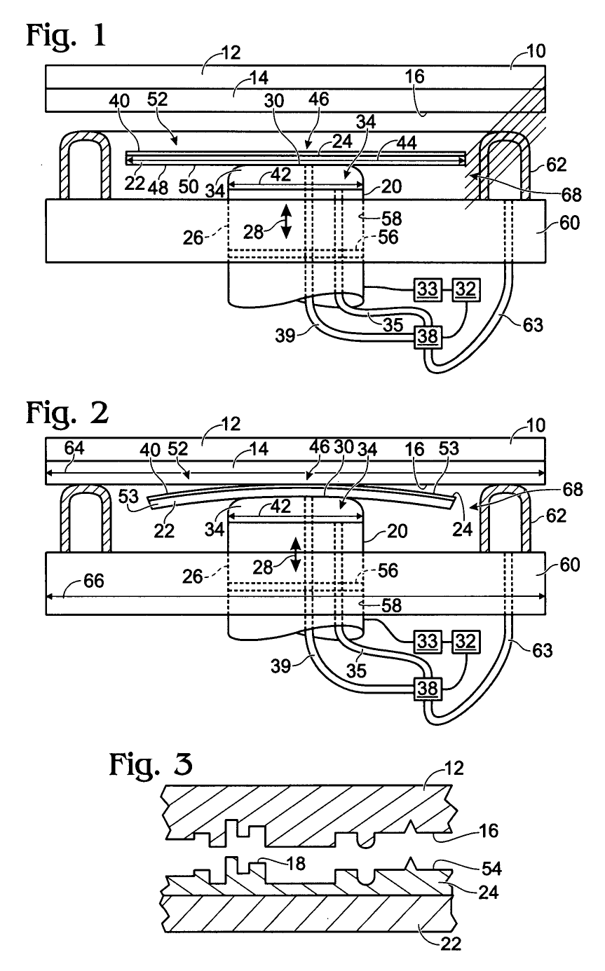

FIGS. 1 and 2 show one example embodiment of a pattern transfer apparatus 10. Apparatus 10 includes a platen support 12 that supports a platen 14 thereon. In the embodiment shown, platen support 12 remains stationary during a pattern transfer process. However, in other embodiments, platen support 12 may be moved during the transfer process.

Platen 14 may be secured to platen support 12 by any method, such as vacuum pressure or adhesive, for example. Platen 14 may include a nano imprinted pattern 16 thereon, wherein pattern 16 may define a mirror image pattern of a plurality of micro electronic structures 18 (see FIG. 3). Micro electronic structures 18 may be electronic resistors, diodes, capacitors or transistors, for example. In the example embodiment shown, platen support 12 and platen 14 may be manufactured of a non-deformable, rigid material.

Apparatus 10 may further include a substrate support 20 that may support thereon a substrate 22, such as a silicon wafer, for example. Substrate 22 may include thereon a coating 24 that may be manufactured of a deformable material that may allow transfer of pattern 16 thereto from platen 14. Coating 24 may be manufactured of any material that may be suited to receive a pattern therein, such as a deformable material, or the like. Coating 24, as shown in FIG. 3, includes the mirror image pattern 54 which has been imprinted by pattern 16. Coating 24, as shown in FIGS. 1 and 2, has not yet been imprinted by pattern 16.

Substrate support 20 may include a cylinder 26 movable along an axis of movement 28 positioned perpendicular to a support surface 30 of substrate support 20. Movement of substrate support 20 may be controlled by a controller 32, such as a computer and/or pneumatic control valves, and motors 33, such as a piezoelectric motor, for example. In one embodiment, cylinder 26 may be moved toward platen 14 to position substrate 22 adjacent to but not in contact with platen 14, so as to ready substrate 22 for subsequent transfer of pattern 16 to substrate 22. In the figures shown, controller 32 and motors 33 are shown schematically. In one embodiment motors 33 may be located below base 60 and may move base 60 in the x, y and z directions.

Substrate support 20 may further include an inflatable membrane 34, such as a bladder, secured to cylinder 26. In one example embodiment, inflatable membrane 34 may be manufactured of silicon rubber and may be adhered with an epoxy to cylinder 26, which may be manufactured of metal. Inflatable membrane 34 may comprise one single membrane secured to cylinder 26 and therefore may define a contained inner cavity 36 therein. Inflatable membrane 34 may be connected by tubing 35 to a pressurization system 38, and thereby to controller 32, such that inflatable membrane 34 may be inflated to controllably move a top surface 40 of substrate 22, including coating 24, into contact with pattern 16 on platen 14. Pressurization system 38 may include tubing 39 that may extend through cylinder 26 and terminate adjacent a substrate 22 positioned on substrate support 20, so as to allow the application of vacuum pressure to a substrate 22 positioned on substrate support 20. In another embodiment, a single tubing system may be utilized to apply pressure to inflate/deflate membrane 34 and to cause movement of cylinder 26.

Inflatable membrane 34 may define a width dimension 42 that is smaller than a width dimension 44 of substrate 22 such that inflatable membrane 34 may contact and support only a portion of substrate 22. In an example embodiment wherein platen 14 and substrate 22 both define planar structures with a round perimeter, width dimensions 42 and 44 may define the diameter of the platen 14 and the substrate 22, respectively. In one example embodiment, inflatable membrane 34 contacts and supports substrate 22 only in a central region 46 thereof, wherein central region 46 defines approximately one half of a total surface area 48 of an underside 50 of substrate 22. Accordingly, as inflatable membrane 34 is inflated and moves substrate 22 into engagement with platen 14, substrate 22 may be unsupported by inflatable membrane 34 in an edge region 52 of substrate 22, and the edge region 52 of substrate 22 may be held on the outermost portion of base 60 by vacuum pressure within base 60, such that substrate 22 may bow slightly 53 in edge region 52 (see FIG. 2, wherein the bow of substrate 22 is exaggerated for ease of illustration). In one example embodiment, the bow 53 of substrate 22 with respect to a flat, nominal position of substrate 22 may be one-one thousandth of an inch in an edge region of the substrate. Such bowing of substrate 22 during the pattern transfer process may allow central region 46 of substrate 22 to firmly contact pattern 16 prior to edge region 52 of substrate 22 being moved into firm contact with pattern 16. Accordingly, such bowing of substrate 22, due to the smaller size of inflatable membrane 34 with respect to the size of substrate 22, may allow more precise and uniform transfer of pattern 16 to substrate 22 than prior art methods of pattern transfer. Moreover, such bowing 53 of substrate 22 may also allow removal of substrate 22 from contact with pattern 16 of platen 14 with reduced friction and with reduced damage to the mirror image pattern 54 (see FIG. 3) transferred to substrate 22.

Cylinder 26 may include a seal 56, such as an O-ring, that may define an air tight seal between cylinder 26 and a central aperture 58 of a base 60 through which cylinder 26 moves. Base 60 may include a sealing member 62 that may define a size and a shape so as to contact platen 14 (or platen support 12 in an embodiment wherein platen 14 has a width dimension 64 less than a width dimension 66 of sealing member 60) without contacting substrate 22. In one example embodiment, sealing member 62 may define an inflatable ring that may be connected by tubing 63 to pressurization system 38 and controller 32, such that sealing member 62 may be inflated to define a controlled atmosphere 68 between platen 14 and base 60. In one example method of transferring a pattern 16, controlled atmosphere 68 between platen 14 and base 60 may be purged of air and filled with a nitrogen gas, for example. After pattern 16 has been transferred to substrate 22, sealing member 62 may be deflated so as to allow removal of substrate 22 from substrate support 20.

Still referring to FIGS. 1 and 2, a method of transferring a pattern 16 will now be described. A platen 14 may be secured to platen support 12 such as by vacuum pressure or adhesive, for example. A substrate 22 may then be positioned on inflatable membrane 34 of substrate support 20, wherein inflatable membrane 34 may be in an deflated condition. Substrate 22 may be secured to substrate support 20 by vacuum pressure applied through tubing 39, for example. Substrate 22 may be centered on substrate support 20 such that a central region 46 of the substrate 22 is centered on substrate support 20 and such that an edge region 52 of the substrate 22 is unsupported. Cylinder 26 of substrate support 20 may then be moved along axis 28 by motor 33 so as to position substrate 22 close to but not in direct physical contact with pattern 16 on platen 14. Sealing member 62 of base 60 may then be inflated to define an airtight controlled atmosphere 68 between platen 14 and base 60. The controlled atmosphere 68 may then be purged of air and a nitrogen atmosphere created within controlled atmosphere 68. Inflatable membrane 34 may then be controllably inflated by controller 32 and pressurization system 38 to move substrate 22 toward pattern 16 of platen 14 along axis 28. Inflation of inflatable membrane 34 moves coating 24 of substrate 22 into physical contact with pattern 16 of platen 12 such that a mirror image pattern 54 of nano imprinted pattern 16 is imprinted or transferred to coating 24 of substrate 22. After a sufficient amount of time of contact, such as sixty seconds or less, for example, inflatable membrane 34 is deflated. Sealing member 62 of base 60 may then also be deflated. Vacuum pressure may then again be applied by pressurization system 38 to substrate 22 to secure it to substrate support 20. The substrate support 20 is then lowered to move substrate 22 out of physical contact with pattern 16 of platen 14. Vacuum pressure may then be released on substrate support 20 such that substrate 22 may be removed from substrate support 20. A new substrate may then be placed on substrate support 20 and the process may be repeated to pattern a new substrate. In this manner, a mirror image pattern 54 of nano imprinted pattern 16 may be transferred to multiple substrates in a uniform, reliable, cost effective and time efficient manner. Such an imprinting process allows for the fabrication of smaller features than lithographic techniques because of the lithographic process limitation of the wavelength of light at the nano meter scale.

The pressures utilized during one example embodiment of the present invention may range from twenty pounds per square inch (20 psi) to inflate inflatable membrane 34 or to move cylinder 26, down to a negative fourteen psi (−14 psi) vacuum to hold substrate 22 on substrate support 20. However, any pressures may be utilized for a particular application as may be applicable. The process may be conducted at ambient (room) temperature, or at other temperatures as may be desired.

FIG. 3 shows a detailed cross sectional side view of one example embodiment of a pattern 16 and a corresponding mirror image pattern 54 that has been transferred to deformable coating 24 of substrate 22. Mirror image pattern 54 transferred to substrate 22 may define a plurality of micro electronic structures 18.

Other variations and modifications of the concepts described herein may be utilized and fall within the scope of the claims below.

We claim:

1. A method of transferring a nano imprinted pattern to a substrate, comprising:
securing a substrate on an inflatable support;
positioning said substrate adjacent a platen including a nano imprinted pattern thereon; and
inflating said inflatable support to controllably move said substrate into contact with said nano imprinted pattern of said platen.

2. The method of claim 1 wherein said contact of said substrate with said nano imprinted pattern of said platen transfers a mirror image nano imprinted pattern of said nano imprinted pattern onto said substrate.

3. The method of claim 1 wherein said inflatable support contacts said substrate only in a central region thereof.

4. The method of claim 3 wherein said substrate is bowed away from said platen in an edge region of said substrate as said substrate is controllably moved into contact with said platen.

5. The method of claim 1 wherein said platen is stationary during said transferring said nano imprinted pattern and wherein said substrate is moved toward said platen during said transferring said nano imprinted pattern.

6. The method of claim 1 wherein said platen is manufactured of a non-deformable, rigid material.

7. The method of claim 2 wherein said mirror image nano imprinted pattern defines a plurality of nano sized electronic structures.

8. The method of claim 1 wherein said substrate is enclosed within a sealed atmosphere during said transferring of said nano imprinted pattern.

9. The method of claim 1 further comprising deflating said inflatable support to move said substrate out of contact with said platen, and removing said substrate from said inflatable support.

10. An apparatus for transferring a pattern of nano sized electronic structures to a substrate, comprising:
a platen support adapted for receiving thereon a platen including a pattern of nano sized electronic structures; and
a substrate support including an inflatable membrane that defines a substrate support surface positioned adjacent said platen support.

11. The apparatus of claim 10 wherein said inflatable membrane comprises a bladder having an interior connected to a pressurization system.

12. The apparatus of claim 10 wherein said substrate support is movable with respect to said platen support along a movement axis positioned perpendicular to said substrate support surface.

13. The apparatus of claim 10 further comprising a second inflatable membrane that when inflated defines a controlled atmosphere between said platen support and said substrate support.

14. The apparatus of claim 12 further comprising a device that powers movement of said substrate support, said device chosen from one of a piezoelectric device and a pneumatic device.

15. A method of using an apparatus for transferring a pattern of nano sized electronic structures to a substrate, comprising:
securing a substrate on an inflatable bladder of a substrate support;
securing a platen on a platen support; and
inflating said inflatable bladder to move said substrate into contact with said platen so as to transfer a pattern of nano sized electronic structures from said platen to said substrate.

16. The method of claim 15 wherein said platen is held in a stationary position during said transfer.

17. The method of claim 15 wherein said substrate is secured on said inflatable bladder by vacuum pressure.

18. The method of claim 15 wherein said substrate defines a support side positioned on said inflatable bladder, wherein said support side defines a surface area, and wherein said inflatable bladder contacts at most one half of said surface area of said support side of said substrate.
